(19) United States
(12) Patent Application Publication
(10) Pub. No.: US 2020/0219368 A1
(43) Pub. Date: Jul. 9, 2020

(54) I am a man moved by the holy spirit to interpret certain the curtain idea that will have customers and banks prosper

(71) Applicant: Jeffrey Michael Langford, Hamilton, NJ (US)

(72) Inventor: Jeffrey Michael Langford, Hamilton, NJ (US)

(21) Appl. No.: 16/243,664

(22) Filed: Jan. 9, 2019

(51) Int. Cl. G07F 19/00; A47H 23/00

(52) U.S. Cl. CPC G07F 19/201; A47H 23/00

(57) ABSTRACT

I am moved by the Holy Spirit so that customers and banks may prosper. It is to prevent thieves from stealing pin numbers at ATM machines at banks inside and outside of the banks. The curtain hides the pin numbers at the ATM keypad. My invention would be new and would save customers and banks money. Also, it would be new to place a Bible quote and painting on the back of a room darkening curtain at the bank if the banks allow.

(1). The invention is to hang a room darkening curtain in both inside banks (lobby) at the ATM and outside of the banks ATMS and other ATMS. The curtain is to prevent criminals from stealing customers debit card pin numbers and for the curtain to hide the pin numbers at the keypad. When a person gets to the bank lobby the room darkening curtain is open. Before the person puts his or her debit card into the ATM they close the curtain. After he or she gets their cash and their debit card is returned they open the curtain. You make the curtain invention by putting together the room darkening curtain, rod and rings. When the ATM is outside the bank you could have poles, curtain, rod and rings. Then you install all of the parts. One bank I went to is now saying. “Cover the keypad with your hand when entering a pin number”. I suggested this first, to cover the keypad with your hand. The thieves who commit these crimes use pin hole cameras, 360 degree video cameras, virtual cameras, regular cameras, infrared cameras, regular cameras, smart phones, camcorders, telescopes and Binoculars. A lot of money is lost at banks in this country and territories. They steal the pin numbers an place the pin numbers on a card and use that card as a debit card.

They can take a picture or pictures from a long or short distance.

(2) I will quote Bible verses because if the banks allow, I would like to place a quote and a painting on the back of the curtains. This is my idea of the curtain from the Holy Bible Mathew 57:21: “and behold the curtain of the temple was torn in two, from top to bottom and the earth shook, and the rocks were split”. God is the Savior of all men.

(3) From Timothy, “God who will have all man to be saved and come to the knowledge of the truth.

(4) From John, “If he (Jesus) be lifted up, he all will draw all men to himself.

(5) There are over 2 billion religious people in the world.

(6) There are over 2 billion dollars stolen in fraud identity theft.

### BACKGROUND OF INVENTION

1. Brief summary is that people and banks will save money and it is better than people holding their hand over the keypad because they forget or do not know how to do it.

2. Statement of field of endeavor is about ATM machines and for a room darkening curtain to open or dose and to hide pin numbers.

3. Definition of subject matter is to prevent criminals from stealing pin numbers.

4. Description known to you is inspired by the Holy Spirit to stop thieves from using pin hole cameras, 360 degree video cameras, virtual cameras, regular cameras, digital cameras, telescopes, camcorders and bi-noculars.

5. The specific documents are Declaration of Patent, Certification of Micro Entity. Data Sheet. Utility Patent Application Transmittal. Specification, Drawings, Abstract, and Claim.

6. The specific problems were drawing the marginal lines with the ruler, would make the line crooked. Also, writing the word curtains when it should be curtain.

7. Thieves can use pin hole cameras and other cameras to capture pin numbers. A view can be made or recorded in every direction.

### A BRIEF SUMMARY OF THE INVENTION

The general idea of the invention is to prevent thieves from capturing pin numbers at keypad ATM machines. The curtain will hide the pin numbers from any cameras, smart phones, camcorders, telescopes or binoculars. The criminals can place the captured pin numbers on their cards to use as debit cards. Have a curtain in both inside ATMS (lobby) and outside of banks. Use with other ATMS. The object of the invention is a room darkening curtain with a rod and clip rings.

### BRIEF DESCRIPTION OF THE DRAWINGS

FIG. 1: Arrows show open and close curtain. Drawing shows parts of curtain components: curtain, rod and clip rings. The jagged lines are the curtain. Open and close a room darkening curtain like some polling booths for voting.

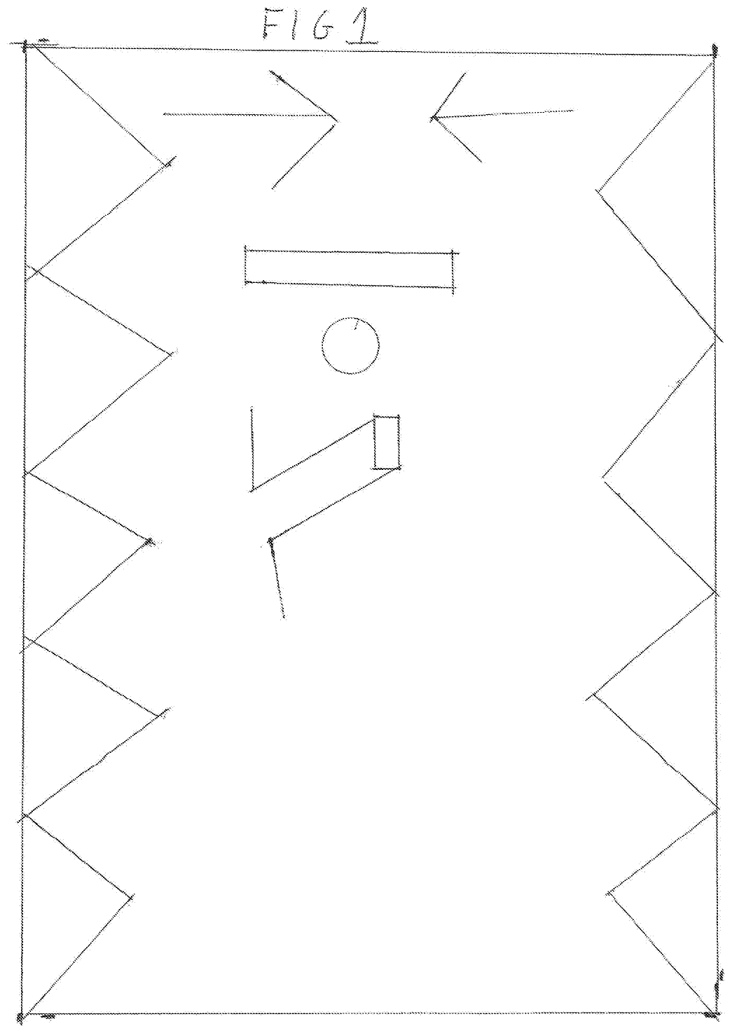

FIG. 2: Arrow shows curtain is closed. Shows ATM keypad. To the right of the keypad is cancel, change and O.K. Lower left rectangular box is where customer receives cash. Upper right box is the statement print out. Lower right box is where to insert debit card.

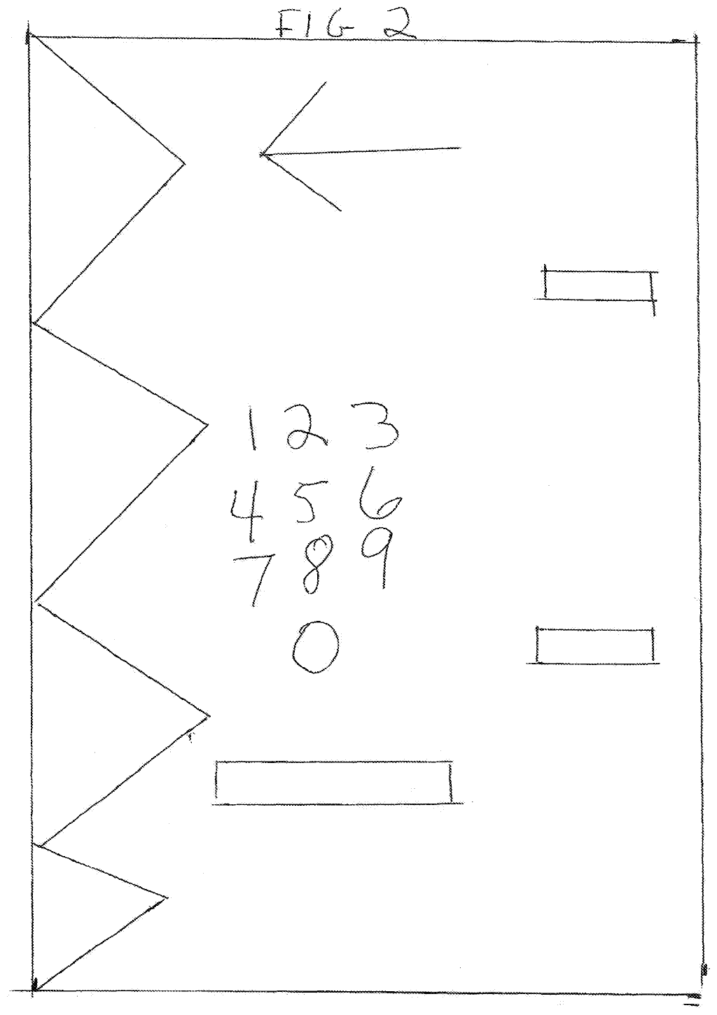

FIG. 3: Arrow shows curtain is closed. On keypad enter pin number.

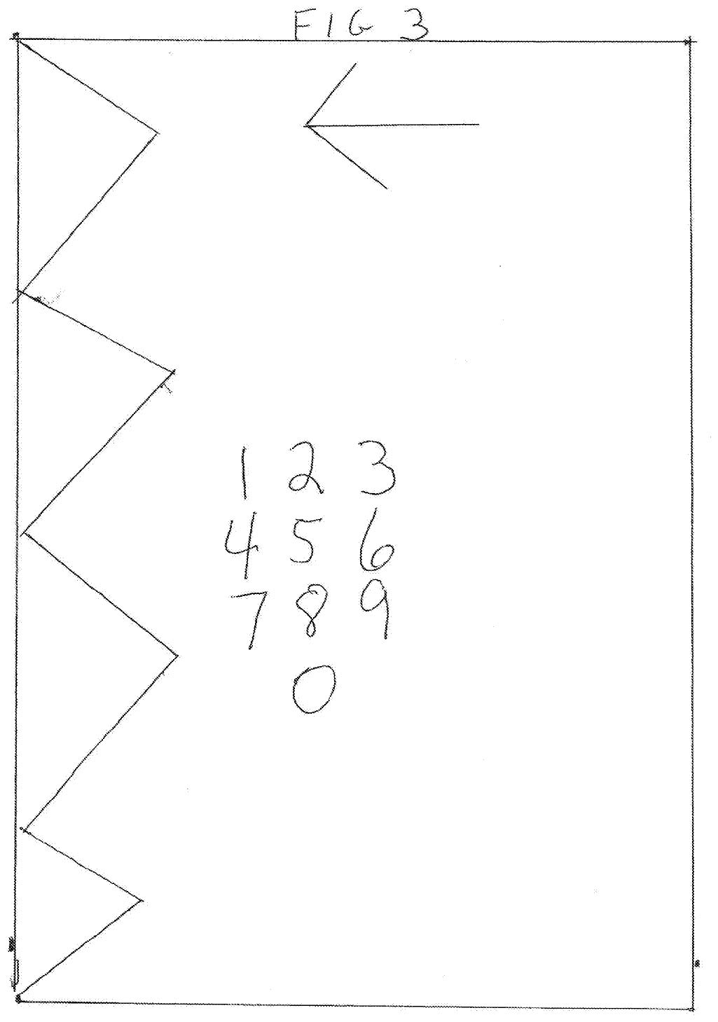

FIG. 4: Arrow shows curtain is closed. Get cash, deposit, or transfer from ATM. Get cash in amount of $20, $40, $50, $80, $100, $150, $200 or $300 from ATM. Get cash, deposit, or transfer statement print out for checking or saving account balance.

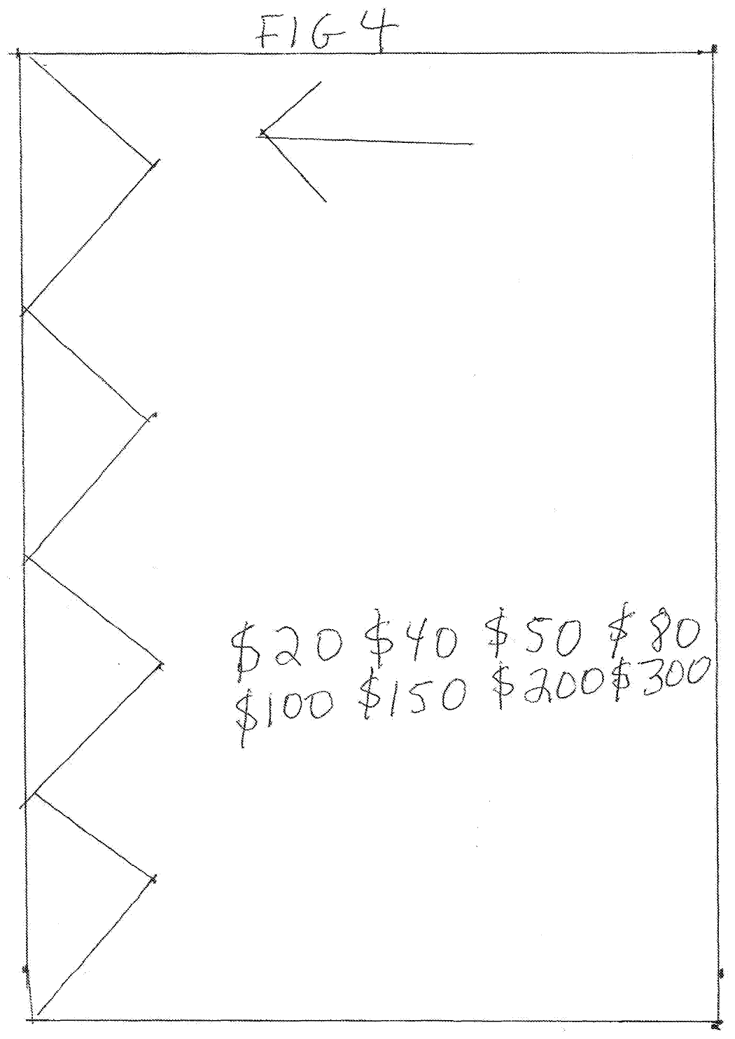

FIG. 5: Arrow shows curtain is closed. Have debit card returned. Arrow shows open curtain.

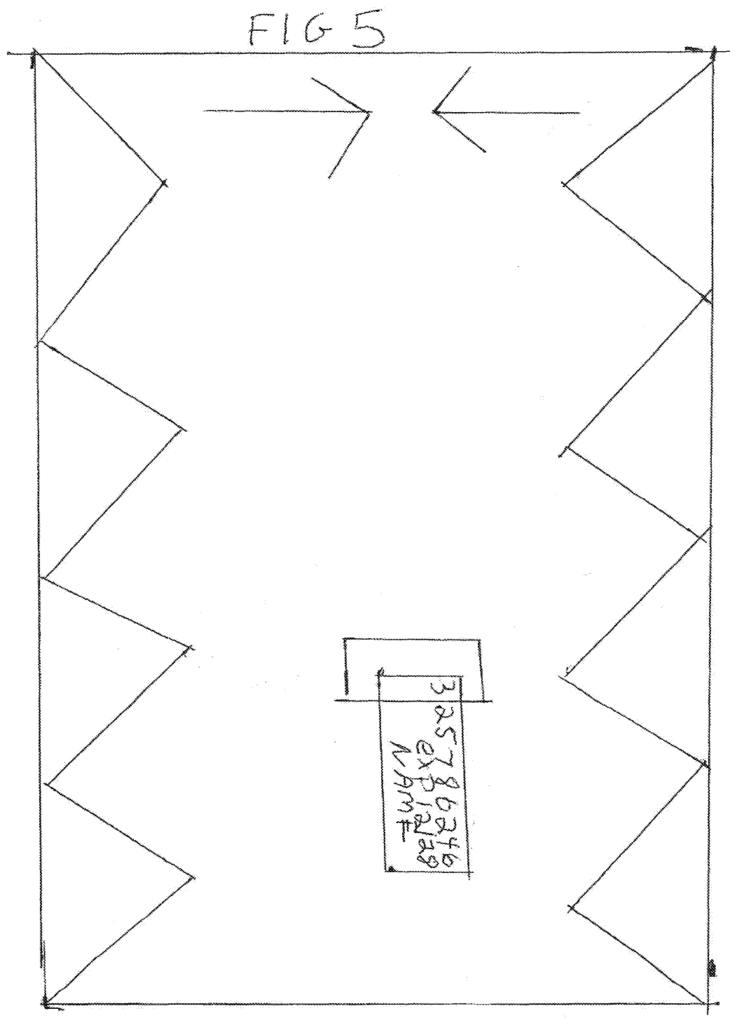

1. A curtain device comprising: to prevent thieves from stealing pin numbers at bank's ATM machines, the curtain can be placed inside or outside of banks, the curtain is to hide numbers being typed on a keypad and the curtain invention is made by putting together curtain, rod and rings.
